(19) United States
(12) Patent Application Publication
(10) Pub. No.: US 2003/0090589 A1
(43) Pub. Date: May 15, 2003

(54) Cover for a display of an image capturing device

(76) Inventors: Mark N. Robins, Greeley, CO (US); Heather N. Bean, Fort Collins, CO (US); Matt Flach, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/047,956

(22) Filed: Oct. 26, 2001

(51) Int. Cl. H04N 5/225

(52) U.S. Cl. 348/373; 348/333.01; 348/376

(57) ABSTRACT

A cover adapted for use with a display screen of an image capturing device includes a cover capable of being positioned over the display screen. The cover is also capable of being retracted away from the display screen, such as by sliding the cover. A guide device retains the cover against a surface of the image capturing device.

### FIELD OF THE INVENTION

The present invention relates generally to an image capturing device, and more particularly to a cover for a display screen of an image capturing device.

### BACKGROUND OF THE INVENTION

Image capturing devices are used to visually memorialize persons, scenes, events, or items. Image capturing devices, such as still and video cameras, include a body, a lens, and some manner of imaging sensor. In addition, many modern electronic cameras include a display screen. The display screen is commonly a liquid crystal display (LCD). The display screen may be used to review captured images or video, or to set up an image capture.

The display screen is typically flush with or only slightly recessed from a surface of the image capturing device. Therefore, it may be scuffed, scratched, or impacted during use, transport, or storage. If the image capturing device is dropped, the LCD display screen may be permanently damaged or broken. This is a problem for the user, as the display screen may be costly to replace, and in addition may require undesirable repair downtime. This is also a problem for the manufacturer in trying to refurbish returned units to a like new appearance.

Image capturing devices of the prior art have not seriously addressed this problem. Many cameras include a transparent plastic film on the display screen when new. The plastic film allows the user to view the display, and may be removed by the user after purchase. Such a film is therefore intended to protect the display screen during manufacture and shipping, but not after purchase and during operation by the user.

A transparent plastic film on the display screen has other drawbacks. The plastic film provides protection only against minor scuffs and scratches, and very little protection against impact. Furthermore, the plastic film may peel off over time, even if the user desires to retain it.

Another prior art approach is a rigid, transparent plastic cover over the display screen. The advantage of such a transparent layer is an improved damage resistance and the ability to easily replace a damaged cover. However, this extra layer of material reduces the light output of the display screen, causes undesirable reflections, and is generally more easily scratched than the LCD surface.

Another prior art approach is to keep the image capturing device in a camera bag or case in order to protect not only the display screen but the entire device. While this is very effective, the display screen may still be damaged when removed from the bag or case for use. In addition, it is not always practical or possible to keep the image capturing device in a case. Moreover, the effectiveness is dependent on the user remembering the case, since it is not an integral part of the image capturing device.

The U.S. Pat. No. 6,003,052 to Yamagata discloses a personal digital assistant (PDA) that includes a display screen and a segmented cover. The cover of Yamagata may be retracted to expose the display screen. A solenoid or pulling spring is incorporated in order to regulate and/or assist in the movement of the cover. Moreover, the cover is retracted into the interior of the PDA, and therefore takes up a portion of the interior volume, increasing the physical size of the device. Also, this cover may be left open while the device is off, unless using an electrically activated embodiment. This results in either reduced battery life or the possibility of the user forgetting to cover the display in the off state, thus leaving it exposed to damage.

Therefore, there remains a need in the art for improvements in image capturing devices.

### SUMMARY OF THE INVENTION

A cover adapted for use with a display screen of an image capturing device comprises a cover capable of being positioned over the display screen. The cover is also capable of being retracted away from the display screen. A guide device retains the cover against a surface of the image capturing device.

### BRIEF DESCRIPTION OF THE DRAWINGS

FIG. 1 shows an image capturing device including a cover according to one embodiment of the invention;

FIG. 2 shows an image capturing device including a cover according to another embodiment of the invention;

FIG. 3 shows an image capturing device including a cover according to yet another embodiment of the invention;

FIG. 4 shows an image capturing device including a cover according to yet another embodiment of the invention.

### DETAILED DESCRIPTION

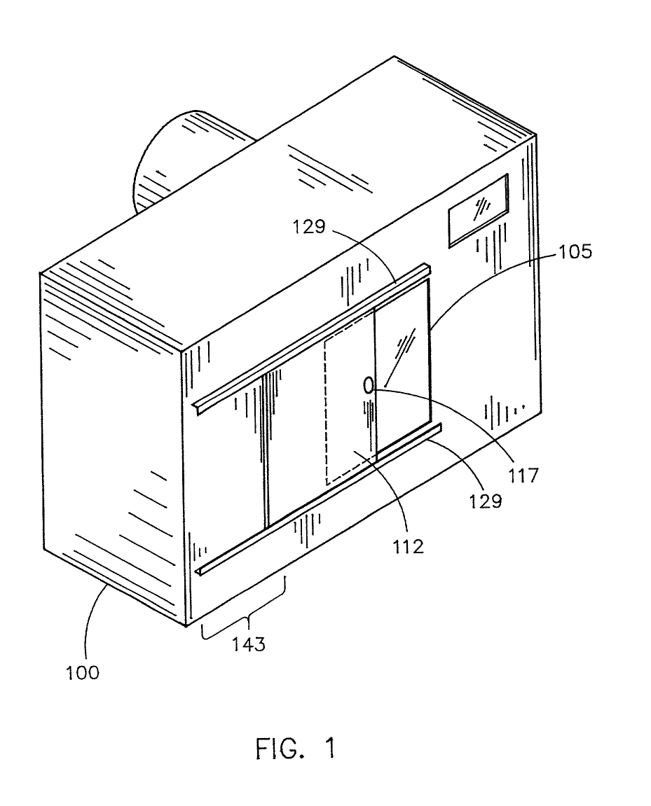

FIG. 1 shows an image capturing device 100 including a cover 112 according to one embodiment of the invention. The image capturing device 100 includes a guide device 129 that retains the cover 112 against the image capturing device 100. The cover 112 may slide in the guide device 129 in order to cover or expose a display screen 105, such as a LCD element, for example.

The image capturing device 100, in this or any embodiment discussed herein, may include an integrated electronic switch that is activated by a motion of the cover 112. Therefore, opening (retracting) the cover 112 may put the image capturing device 100 in a power-on mode and closing the cover 112 may put the image capturing device 100 in a power-off mode. Alternatively, the integrated switch may be used to put the image capturing device 100 in a capture mode when closed, wherein opening the cover 112 may cause the image capturing device 100 to display a real time or previously captured image on the display screen 105.

When not in use, the cover 112 may be positioned over the display screen 105 (i.e., in a closed position) in order to protect the display screen 105. Before use, the cover 112 may be moved to a retracted position. When the cover 112 is retracted away from the display screen 105, the cover 112 may be positioned in extended portions 143 of the guide device 129. The user may manually slide the cover 112.

The guide device 129 may include projections or detents (not shown) positioned at open and closed positions of the cover 112, that restrain the movement of the cover 112. In addition, the guide device 129 may include stops (not shown) at the limits of cover movement that prevent the cover 112 from sliding out of the guide device 129.

The cover 112 and guide device 129 may be formed of any material, such as a hardened plastic or a thin metal, for example. Moreover, the guide device 129 may be integrally formed in the image capturing device 100.

The cover 112 may include a protrusion or recess 117 that gives a user motional control purchase on the cover 112. A finger of the user may be placed beside the protrusion 117 (or in the recess 117), and the user may push against the protrusion or recess 117 in order to slide the cover 112.

In an alternate embodiment, the protrusion or recess 117 may be formed on the cover 112 in a position wherein it becomes part of a camera gripping area when the cover 112 is in an open position. For example, the protrusion or recess 117 may form a place for a user's thumb to rest while using the camera.

The cover 112, in this or any embodiment discussed herein, may optionally include one or more biasing devices (such as a spring). The one or more biasing devices may be included to aid in opening (i.e., retracting) or closing the cover 112. Alternately, the cover 112 may optionally include one or more detents in order to maintain the cover 112 in a fully closed position, in a fully open position, etc.

In the embodiment shown, the guide device comprises a pair of tracks 129 that retain the cover. The tracks 129 may extend from the rear surface of the image capturing device 100. Alternatively, the guide device 129 comprises a pair of grooves formed along two sides of the display screen 105 (and in the image capturing device 100). The pair of grooves retain the cover 112. In another alternative embodiment, the guide device 129 comprises a plurality of finger-like projections (not shown) that trap and retain at least a portion of the cover 112.

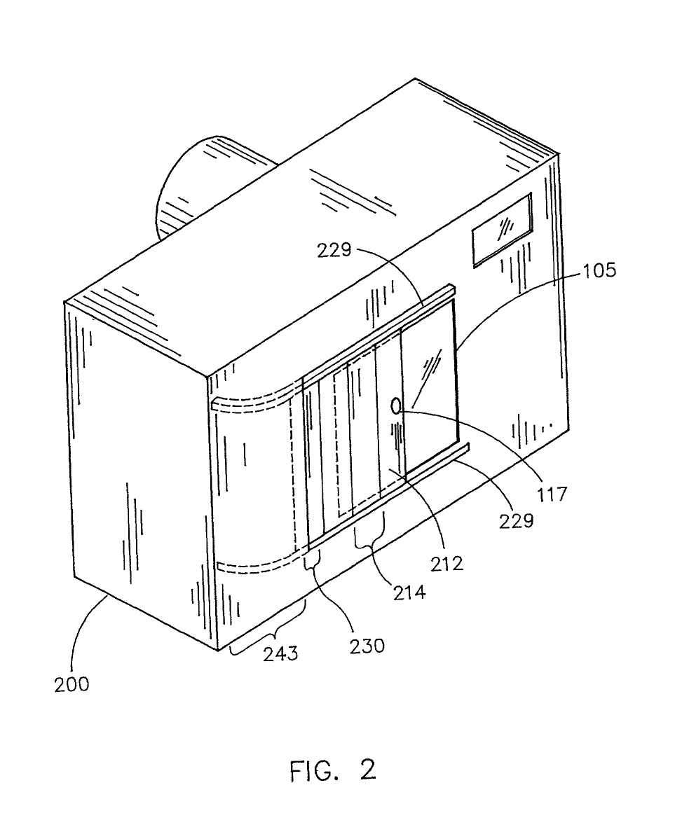

FIG. 2 shows an image capturing device 200 including a cover 212 according to another embodiment of the invention. The components in common with the previous figure retain common reference numerals. In this embodiment, the cover 212 is a segmented cover, wherein the cover 212 may flex to accommodate a non-linear configuration. The tracks 229 therefore include curved portions 243 extending inside the housing of the device 200, and wherein the cover 212 may flex to form a curved surface when retracted. In addition, the image capturing device 200 includes an opening 230 in its exterior surface through which the cover 212 may pass when retracted. The tracks 229 therefore guide the cover 212 into an interior region of the image capturing device 200 when retracted.

The segmented cover 212 may be formed of a plurality of vertical segments 214, with the vertical segments 214 being flexibly joined. The joint may be a hinge, a flexible material, or a flexible portion of the segmented cover 212. If the segmented cover 212 is formed of a plastic, for example, a thinner region of material between the vertical segments 214 may provide the desired flexibility.

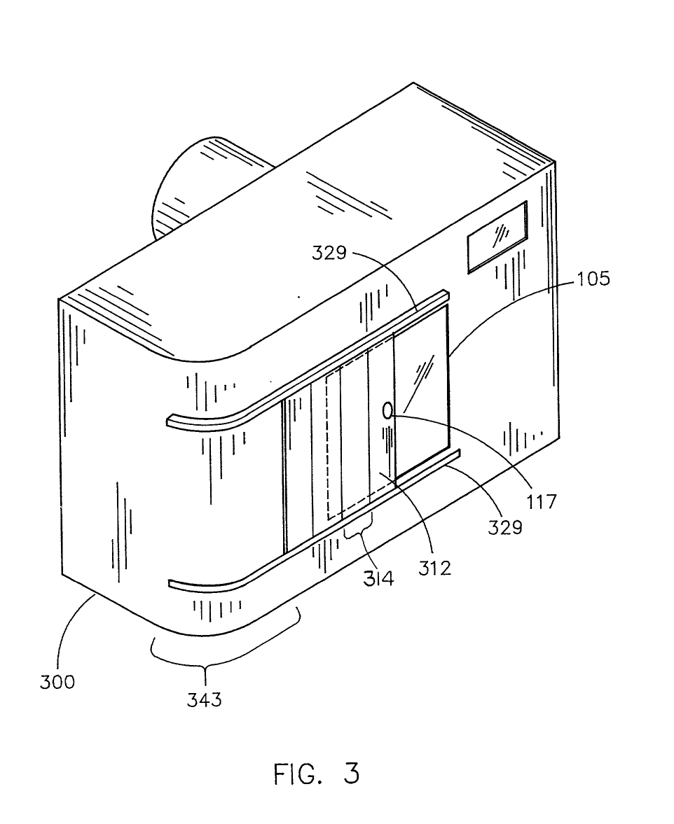

FIG. 3 shows an image capturing device 300 including a cover 312 according to yet another embodiment of the invention. The components in common with the previous figures retain common reference numerals. In this embodiment, the cover 312 is again a segmented cover that slides on a pair of tracks 329. The curved portions 343 of the tracks 329 remain on an exterior surface of the image capturing device 300, and a portion of the exterior surface of the image capturing device 300 therefore may be rounded.

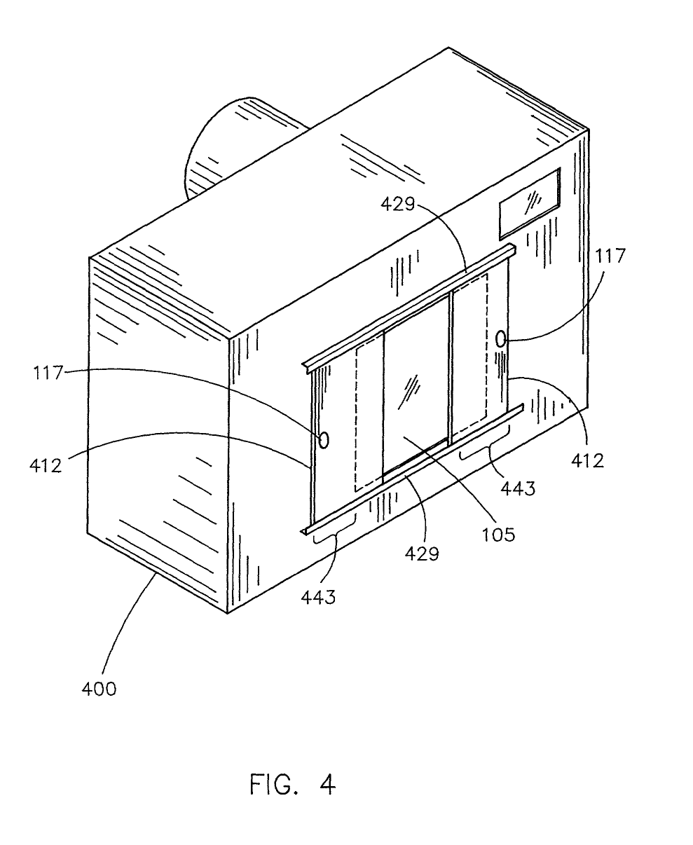

FIG. 4 shows an image capturing device 400 including a cover 412 according to yet another embodiment of the invention. The components in common with the previous figures retain common reference numerals. In this embodiment, the cover 412 is formed of two or more pieces that retract in different directions to reveal the display screen 105. The retraction moves the pieces of the cover 412 along extended portions 443 of the tracks 429. In addition, the pieces of the cover 412 may be mechanically linked so that retraction of one piece retracts all other pieces. It should be noted that although the figure shows the tracks 429 being horizontally arranged, they could be arranged in other orientations. In a further alternate embodiment, the pieces may be hinged and therefore pivoted so that they retract by swinging into the image capturing device 400.

We claim:

1. An image capturing device, comprising:
a display screen integrally formed on a surface of said image capturing device;
a cover capable of being positioned over said display screen and capable of being retracted away from said display screen; and
a guide device that retains said cover against said surface of said image capturing device.

2. The device of claim 1, wherein said cover comprises a segmented cover including a plurality of vertical segments, with said plurality of vertical segments being flexibly joined to each other.

3. The device of claim 1, further comprising a protrusion formed on said cover.

4. The device of claim 1, further comprising a protrusion or recess formed on said cover and wherein said protrusion or recess is part of a camera gripping area when said cover is retracted.

5. The device of claim 1, wherein said cover remains outside said image capturing device when retracted.

6. The device of claim 1, wherein said guide device comprises a pair of grooves formed in said image capturing device along said display screen and wherein said cover slides in said pair of grooves.

7. The device of claim 1, wherein said guide device comprises a pair of linear tracks formed as part of a surface of said image capturing device and wherein said cover moves along said surface.

8. The device of claim 1, wherein said cover is manually positioned over said display screen and is manually retracted away from said display screen.

9. The device of claim 2, wherein said guide device comprises a pair of partially curved tracks formed as part of an exterior surface of said image capturing device, with said exterior surface including a curved portion and wherein said cover moves along said exterior surface.

10. The device of claim 2, further comprising an opening in said image capturing device of a size and location to allow said cover to pass into said image capturing device when said cover is retracted and wherein said guide device comprises a pair of tracks including curved portions that curve into an interior region of said image capturing device.

11. The device of claim 1, wherein said cover comprises two or more pieces.

12. The device of claim 1, wherein said cover comprises two or more pieces and said two or more pieces are mechanically linked so that retraction of a particular cover piece retracts all other cover pieces.

13. The device of claim 1, further comprising an integrated electrical switch that is activated by a retraction motion of said cover.

14. A cover adapted for use with a display screen of an image capturing device, comprising:
a segmented cover capable of being manually positioned over said display screen and capable of being manually retracted away from said display screen;
a guide device that retains said segmented cover against a back surface of said image capturing device; and
a protrusion formed on said segmented cover.

15. The cover of claim 14, said segmented cover including a plurality of vertical segments, with said plurality of vertical segments being flexibly joined to each other.

16. The cover of claim 14, wherein said segmented cover remains outside said image capturing device when retracted.

17. The cover of claim 14, wherein said guide device comprises a pair of grooves formed in said image capturing device along said display screen and wherein said segmented cover slides in said pair of grooves.

18. The cover of claim 14, wherein said guide device comprises a pair of linear tracks formed as part of a surface of said image capturing device and wherein said segmented cover moves along said surface.

19. The cover of claim 14, wherein said guide device comprises a pair of partially curved tracks formed as part of an exterior surface of said image capturing device, with said exterior surface including a curved portion and wherein said segmented cover moves along said exterior surface.

20. The cover of claim 14, further comprising an opening in said image capturing device of a size and location to allow said segmented cover to pass into said image capturing device when said segmented cover is retracted and wherein said guide device comprises a pair of tracks including curved portions that curve into an interior region of said image capturing device.
